(19) United States
(12) Patent Application Publication
(10) Pub. No.: US 2009/0324928 A1
(43) Pub. Date: Dec. 31, 2009

(54) Forming ultra low dielectric constant porous dielectric films and structures formed thereby

(76) Inventors: Vijayakumar Ramachandrarao, Portland, OR (US); Grant Kloster, Lake Oswego, OR (US); Boyan Boyanov, Portland, OR (US)

Correspondence Address: INTEL CORPORATION;c/o CPA Global, P.O. BOX 52050, MINNEAPOLIS, MN, 55402, US

(21) Appl. No.: 12/215,522

(22) Filed: Jun. 26, 2008

(51) Int. Cl. G21G 5/00; B32B 5/18

(52) U.S. Cl. 428/315.5; 250/492.1; 428/304.4

(57) ABSTRACT

Methods of forming a microelectronic structure are described. Embodiments of those methods include removing a portion of at least one of Si—C bonds and CHx bonds in a dielectric material comprising a porogen material by reaction with a wet chemical, wherein the portion of Si—C and CHx bonds are converted to Si—H bonds. The Si—H bonds may be further hydrolyzed to form SiOH linkages. The SiOH linkages may then be removed by a radiation based cure, wherein a portion of the porogen material is also removed.

### BACKGROUND OF THE INVENTION

As microelectronic device sizes continue to shrink, there is a continued demand for low k interlayer dielectric (ILD) materials. Certain low k materials have been proposed, including various carbon-containing materials such as organic polymers and carbon-doped oxides (CDO). Such low dielectric constant materials may serve to reduce the resistance-capacitance (RC) delay of a microelectronic device and thus may contribute to improved device performance. Porous dielectrics have been looked into for insertion in the backend of line for a few generations now. One of the downsides of this material is the reduced mechanical properties of the material due to the inherent porosity of the material that is needed for the lower dielectric constant.

### BRIEF DESCRIPTION OF THE DRAWINGS

While the specification concludes with claims particularly pointing out and distinctly claiming certain embodiments of the present invention, the advantages of this invention can be more readily ascertained from the following description of the invention when read in conjunction with the accompanying drawings in which:

FIGS. 1a-1i represent methods of forming structures according to an embodiment of the present invention.

FIG. 2 represents a flowchart according to an embodiment of the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the

Methods and associated structures of forming and utilizing a microelectronic structure, such as a porous low k dielectric layer, are described. Those methods may comprise removing a portion of Si—C and CHx bonds in a dielectric material comprising a porogen material by reaction with an aqueous or solvent-based wet chemical, wherein the portion of Si—C bonds are converted to Si—H bonds. The Si—H bonds may be further hydrolyzed to form SiOH linkages. The SiOH linkages may then be removed by a radiation based cure, wherein a portion or substantially all of the porogen material is also removed. The various embodiments of the present invention achieve superior mechanical properties for dielectric films at a given low dielectric constant value, while allowing for increased porosity of the film, on the order of about 25 percent to about 40 percent porosity.

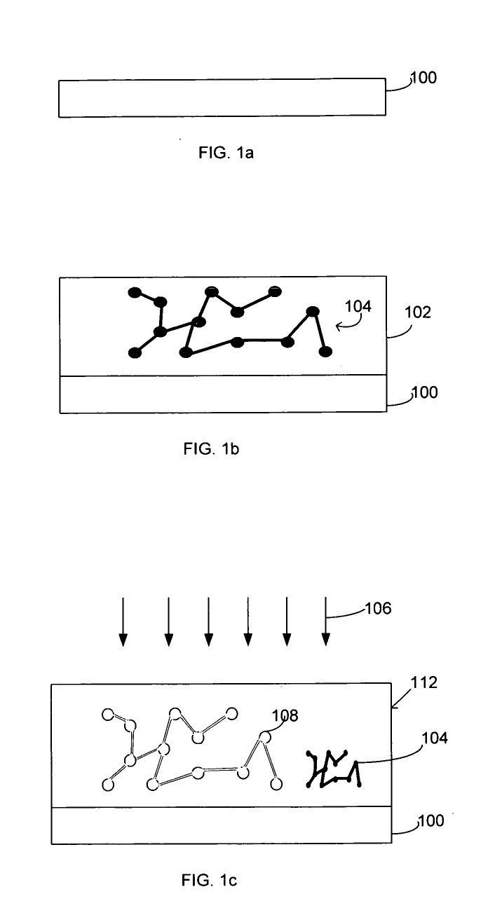

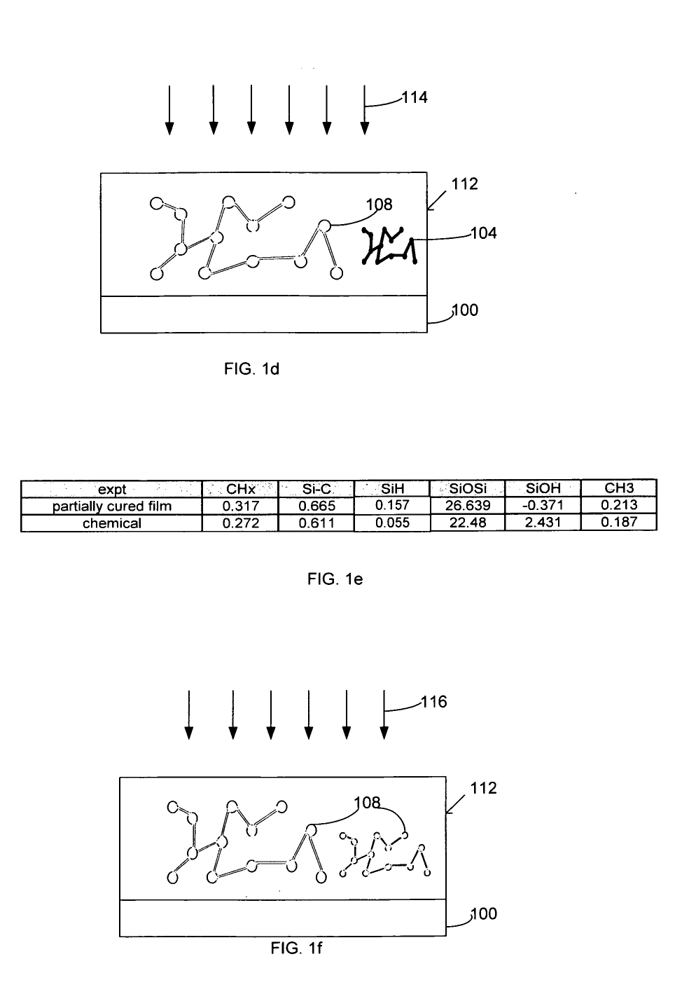

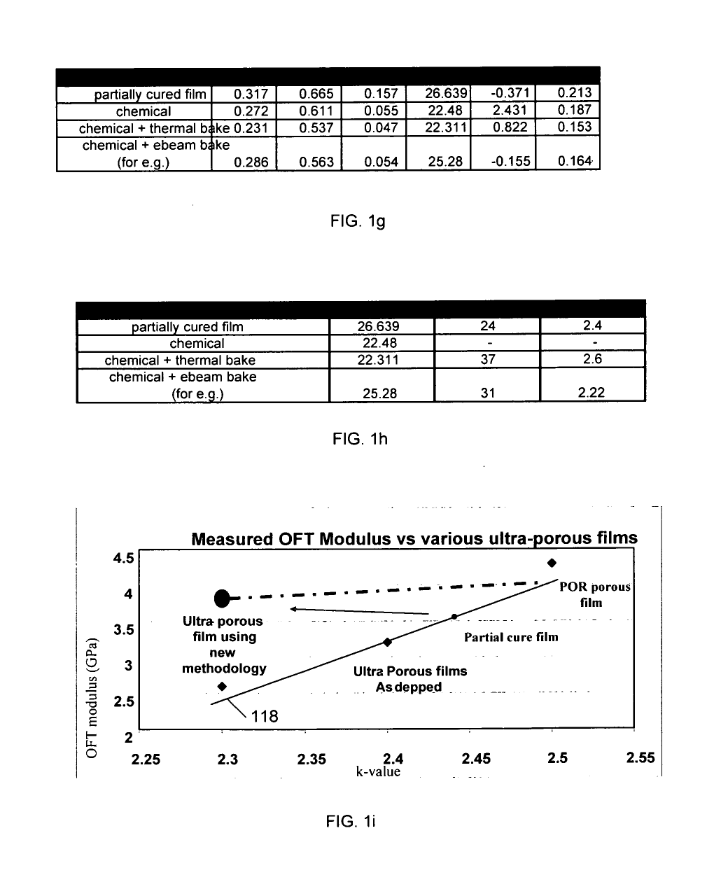

FIGS. 1a-1i illustrate an embodiment of a method of forming a microelectronic structure, such as a porous dielectric layer, for example. FIG. 1a illustrates a substrate 100. The substrate 100 may comprise any surface that may be generated when making a microelectronic device, upon which an insulating layer may be formed. The substrate 100 may include, for example, active and passive devices that are formed on a silicon wafer such as transistors, capacitors, resistors, diffused junctions, gate electrodes, local interconnects, etc. The substrate 100 may also include insulating materials (e.g., silicon dioxide, either undoped or doped with phosphorus (PSG) or boron and phosphorus (BPSG), silicon nitride, silicon oxynitride, silicon carbide, carbon doped oxide, or a polymer) that separate such active and passive devices from conductive layers that are formed on top of them, and may include various types of conductive layers, for example.

A dielectric material 102 may be formed on the substrate 100 (FIG. 1b). In one embodiment, the dielectric material 102 may be formed utilizing a plasma process, such as but not limited to a chemical vapor deposition (CVD) and plasma enhanced vapor deposition (PECVD) processes, for example, and may comprise an ILD in some cases. Other dielectric material 102 formation techniques may be utilized, according to the particular application. It is advantageous to lower the dielectric constant (k value) of the dielectric material 102 for microelectronic device applications, such as when the dielectric material 102 may be used as an insulative dielectric material to insulate metallic conductive interconnect structures, for example.

In an embodiment, the dielectric layer 102 may comprise a porogen material 104, as is well known in the art. In one embodiment, the porogen material 104 may comprise at least one of alpha-terpenine or phenylbutadiene, other labile organic species and/or poly propylene glycol, methyl methacrylate, poly epsilon caprolactone, and poly ethylene oxide-b-propylene oxide-b-ethylene oxide materials. The porogen material 104 may in general comprise any such material that may be exposed to an energy (subsequent to incorporation and/or polymerization within the formed dielectric layer 102) that may decompose and/or vaporize the porogen material 104. The decomposition and/or vaporization of the porogen 104 in a subsequent process step may leave a void, or a pore within the dielectric layer 102 where the porogen material 104 previously occupied space.

In one embodiment, energy 106 may be applied to the dielectric layer 102, wherein some of the porogen material 104 disposed within the dielectric layer 102 may decompose and/or volatize to form at least one pore 108, as is well known in the art (FIG. 1c). In one embodiment, the energy 106 that may be applied to the dielectric layer 102 may comprise at least one of ultraviolet (UV) energy and electron beam radiation energy.

The type and amount of energy 106 applied to the dielectric layer 102 may vary according to the particular application, but the energy 106 applied to selectively decompose some of the porogen material 104 may be such that it does not substantially decompose the dielectric layer 102, as is well known in the art. In an embodiment, the energy 106 may partially cure the dielectric material 102, in other words, some of the porogen may remain un-volatized (may not form pores) within the dielectric material 102. In another embodiment, the dielectric material 102 may alternately not be exposed to the energy 106, thus the dielectric material 102 may remain uncured, and the porogen 104 within the dielectric material 102 may remain un-volatized/un-decomposed.

Thus, by applying energy 106 to the porogen material 104 dispersed within the dielectric layer 102 to form the at least one pore 108, a porous dielectric material 112 may be formed. In one embodiment, the porous dielectric material 112 may comprise a dielectric constant less than silicon dioxide. In one embodiment, the porous dielectric material 112 may comprise a dielectric constant (k value) between about 2.5 and about 3. In an embodiment, the porosity of the porous dielectric may comprise up to about 24 percent porosity, and in some cases may comprise little to no porosity. In an embodiment, the porous dielectric material 112 may comprise a dielectric material comprising a porogen material.

Introducing pores, and thus porosity, to the dielectric material 102 may serve to lower the dielectric constant (k value) of the dielectric material 102, since the dielectric constant of air is 1.0. One of the challenges of adding porosity to prior art dielectric materials is that the net Young's modulus and the hardness of prior art dielectric materials tend to drop due to the inclusion of air-pockets in the bulk of such prior art dielectric materials.

In an embodiment, the porous (that may be porogen loaded, with un-decomposed pores) dielectric material 112 (either uncured or partially cured) may be treating with a wet chemical 114 (FIG. 1d). The wet chemical 114 may comprise deionized water, solvent-based wet chemicals that contain such solvents as glycols, glycol ethers, sulfolane, n-methyl-2-pyrrolidone (NMP), alkaline materials such as Tetramethylammonium Hydroxide (TMAH), and potassium hydroxide (KOH), with or without the use of dissolved ozone or ozone vapor, by illustration and not limitation. Chemical bonds within the porous dielectric material 112, such as CHx, Si—CH3 & Si—CHx bonds, may be attacked by the wet chemical 114, so that a portion of the chemical bonds, such as the CHx, Si—CHx bonds, present in the porous dielectric material 112 may be removed.

Si—H bonds may be left behind in the porous dielectric material 112 after reaction of the chemical bonds (such as Si—C bonds) with the wet chemical 114. These Si—H bonds may then be hydrolyzed to form Si—OH bonds. The hydrolysis of the Si—H bonds to Si—OH bonds results in a significant reduction in Si—H linkages that are usually present in prior art CVD-based porous dielectrics. This reduction in Si—H bonds can be observed in Infrared (IR) spectra of the porous dielectric material 112 measured after formation and after the treatment with the wet chemical 114. The removal of the porogen can be tracked by monitoring the area under the CHx and Si—C peaks of the IR spectra. For example, FIG. 1e shows a table in which the area under the curve for Si—CH3 & Si—CHx peaks depict a reduction in Si—CH3 & Si—CHx bonds after treatment of the uncured (non-porous ) or partially cured (semi-porous) dielectric material with the chemical 114, and thus a corresponding reduction in SiH bonds. In some cases, the reduction rate in SiH bonds may be up to about a 60 percent over prior art porous dielectric materials. FIG. 1e also shows the formation and increase of SiOH bonds which correspond to Si—H bond hydrolysis by the chemical 114.

These SiOH linkages are very reactive in general and especially among themselves and can cross link and hence lead to a more connected matrix of the porous dielectric 112. Additionally, SiOSi linkages are reduced, as can be seen in FIG. 1e, and are also converted to SiOH linkages by the chemical treatment 114.

The SiOH linkages in the porous dielectric film 112 can be removed with a thermal cure or radiation-based cure 116 after chemical treatment 114, such as with an ebeam and/or a UV cure (FIG. 1f). FIG. 1g shows a much higher efficiency in the SiOH linkage removal with UV/ebeam than with thermal energy. Also shown is the amount of Si—O—Si linkages in the respective films, which increases because of the reaction of SiOH linkages among themselves after the radiation based cure 116. In an embodiment, Si—H bonds may be replaced with stronger SiOSi linkages. In an embodiment, replacing the Si—H bonds with Si—O—Si linkages may increase the porosity of the porous dielectric material 112.

The radiation based cure 116 may also serve to substantially remove any/a portion of un-decomposed porogen that may remain in the chemically treated partially or un-cured porous dielectric material 112 (refer back to FIG. 1f). This further curing 116 will lead to a net increase in the porosity of the porous dielectric material 112 relative to the starting value. The porosity of the porous dielectric material 112 will be increased while the mechanical properties will be enhanced.

FIG. 1h shows porosity & dielectric constant (k) of the porous dielectric material 112. The extra cross linking within the porous dielectric material 112 accompanied with greater porosity (due to the dual removal of the porogen by the chemical treatment 114 and the generation of SiOH linkages from the less useful SiH bonds), results in a lower dielectric constant and a higher porosity percentage. The porosity may comprise between about 24 percent to about 40 percent in some embodiments, but will vary according to the particular process parameters of formation. The dielectric constant may range from about 2.4 to less than about 2.2 in some embodiments.

The porous dielectric material 112 may comprise superior mechanical properties, specifically with respect to the hardness and modulus. FIG. 1i shows the mechanical properties of the respective films. FIG. 1i shows a graph (line) wherein as the dielectric constant decreases, so typically does the strength of prior art films 118. The hardness and Young's modulus of the porous dielectric material 112 of the present invention may be increased because the chemical bonds that give rise to the matrix of the porous dielectric material 112, such as the Si—CH3 & Si—CHx bonds in the uncured or partially cured dielectric films, may be attacked by the wet chemical 114, and the subsequent extra cross linking within the porous dielectric material 112 serves to. strengthen the material. This is essentially accomplished by removing some of the less useful Si—CH3 or Si—CHx linkages and replacing them with the desired Si—O—Si cross-linkages with increased porosity (a controlled change from a porous CDO to a more porous CDO/SiO2 mixture, for example).

By treating a dielectric material comprising a porogen (either partially cured or non-cured) with a wet chemical according to the embodiments of the present invention, the k value may be decreased to below about 2.4 (to about 2.2), while increasing the hardness to above about 1.4 GPa (from nano-indentation, for example) and the Young's modulus to above about 3.5 GPA as measured by surface acoustic wave (SAW) technique and greater than about 7.4 GPa as measured by nano-indentation. These benefits of the present invention may be easily extended to patterned wafers where a porous dielectric film laden with porogen may be patterned, metallized and then a final radiation cure (ebeam/UV) can be performed to lower the k value of the film, while greatly improving mechanical properties.

This technique can also be applied to porous dielectric materials having k-values of around 2.5 to increase their inherent mechanical properties (by adjusting porogen loading, curing conditions, etc., for example) and may also be applied to ultra-porous dielectrics comprising higher porosity and lower k-value (dielectric constant <<2.5) to improve their mechanical properties while achieving k values below about 2.5, in some embodiments.

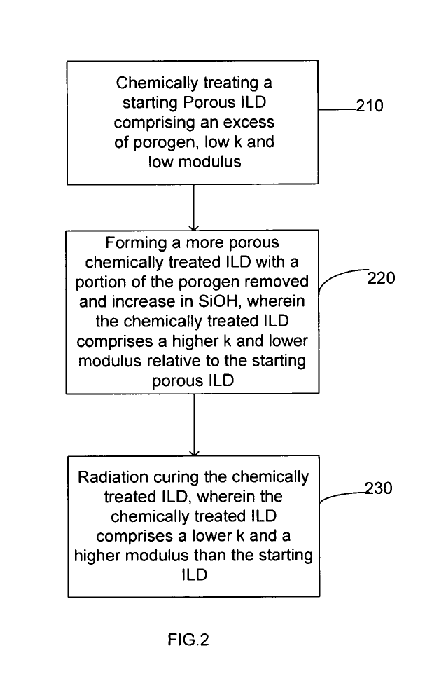

FIG. 2 depicts a flowchart of another embodiment of the present invention. At step 210, a starting porous ILD comprising an excess of porogen, a low k and a low modulus may be chemically treated. At step 220, a more porous ILD with a portion of the porogen removed and increased SiOH may be formed, wherein the chemically treated ILD comprises a higher k and lower modulus relative to the starting porous ILD. At step 230, the chemically treated ILD may be radiation cured, wherein the chemically treated ILD comprises a lower k and a higher modulus than the starting ILD, and the best porous ILD that could be obtained by complete curing in a single step. Thus, the porogen and the Si—C bonds may be removed, as well as Si—OH, to yield a low k, high modulus, high hardness ILD.

The benefits of the embodiments of the present invention include, but are not limited to, the enhancement of mechanical properties of porous and non-porous dielectrics. Methods of the various embodiments of the present invention enable a solution to the so-called death curve of ILD with respect to its k-value and mechanical strength. High porosity, low k films are needed for the lower dielectric constant uses for various microelectronic applications, and these methods enable the increase in mechanical properties of such films. Ultra-low dielectric constants of 2.2 are enabled. The dielectric materials of the various embodiments of the present invention may be formed by CVD and may comprise carbon-containing materials such as organic polymers, carbon-doped oxides, spin on dielectric materials, and other suitable dielectric materials, and may serve to reduce the RC delay of a microelectronic device, and thus may contribute to improved device performance. In an embodiment, the dielectric material of the various embodiments may serve as an insulator material between conductive lines in a device.

Removal of the SiH and Si—CHx bonds chemically from a partially/incompletely/non-cured CVD-based porous dielectric film (w/some amount of porogen still inside the film) and replacement of the SiH and Si—CHx bonds with stronger SiOSi linkages increases the mechanical properties of porous (and non-porous) dielectric films for the equivalent or lower dielectric constant. The porosity increases concomitantly yielding a more porous material with a much lower k value for the same porogen loading. Porogen removal and radiation curing of the dielectric enhances the mechanical properties, wherein the porogen is chemically removed by dissolution, thereby creating SiOH bonds which are selectively reacted to form a more porous (around 40% porosity or greater) and a stronger material (with properties similar to a 24% porous material). The methods of the present invention can be applied on dielectric blanket films (as they are deposited) or can be applied on a patterned wafer at specific patterning step(s), such as after metalization.

Pore size and pore-size distribution of the porous dielectric film of the embodiments of the invention may comprise a pore size distribution that is a multiimodal pore size distribution, wherein the pore size comprises greater than about a 1.3 nm radius (that may be measured via ellipsometric porosimetry). Prior art dielectric films may generally comprise a unimodal pore-size distribution or pore size of about 1.1-1.3 nm radius.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that various microelectronic structures, such as dielectric layers, are well known in the art. Therefore, the Figures provided herein illustrate only portions of an exemplary microelectronic structure that pertains to the practice of the present invention. Thus the present invention is not limited to the structures described herein.

What is claimed is:

1. A method of forming a structure comprising;
removing a portion of at least one of Si—C bonds and CHx bonds in a dielectric material comprising a porogen material by reaction with a wet chemical, wherein the portion of the Si—C bonds and the CHx bonds are converted to Si—H bonds, and wherein the Si—H bonds further hydrolyze to form SiOH linkages; and
removing the SiOH linkages by a radiation based cure, wherein a portion of the porogen material is also removed.

2. The method of claim 1 wherein removing a portion of the porogen material comprises removing at least one of alpha-terpenine, phenylbutadiene, poly propylene glycol, methyl methacrylate, poly epsilon caprolactone, and poly ethylene oxide-b- propylene oxide-b-ethylene oxide materials, and wherein the porogen is removed from at least one of a blanket dielectric material and a patterned dielectric material comprising metalization.

3. The method of claim 1 further comprising wherein removing the porogen comprises lowering the k value of the dielectric material to below about 2.4.

4. The method of claim 3 further comprising wherein a hardness of the dielectric material is strengthened above about 1.4 GPa, and a Young's modulus of the dielectric material comprises above about 3.5 GPA as measured by SAW techniques and greater than about 7.4 GPa as measured by nano-indentation.

5. The method of claim 1 further comprising wherein the dielectric material is formed by PECVD and comprises at least one of organic polymers, carbon-doped oxides and spin on dielectric materials.

6. The method of claim 1 further comprising wherein the Si—C and CHx bonds are replaced with stronger SiOSi linkages.

7. The method of claim 6 wherein replacing the Si—C and CHx bonds with Si—O—Si linkages increases the porosity of the dielectric material.

8. The method of claim 1 further comprising wherein the dielectric material comprises a porosity of between about 24 percent and about 40 percent.

9. The method of claim 1 wherein removing the SiOH linkages by a radiation based cure comprises removing the SiOH linkages by at least one of an ultraviolate energy and an electron beam energy.

10. The method of claim 1 further comprising wherein the wet chemical comprises at least one of deionized water, glycols, glycol ethers, sulfolane, n-methyl-2-pyrrolidone, alkaline materials, Tetramethylammonium Hydroxide, and potassium hydroxide.

11. A method comprising:
partially curing a porogen loaded ILD by using a radiation based cure;
removing Si—CHx and CHx bonds in the ILD with a solvent-based wet chemical, wherein SiOH linkages are formed; and
further curing the ILD with at least one of ebeam and UV curing to remove the porogen and to remove the SiOH linkages.

12. The method of claim 12 further comprising wherein a k value of the ILD is lowered to below about 2.4, and a hardness of the ILD is increased above about 1.2 GPa.

13. A structure comprising:
a porous dielectric layer, wherein the porous dielectric layer comprises a k value of below about 2.4 and a hardness of above about 1.4 GPa.

14. The structure of claim 13 wherein a Young's modulus of the dielectric material comprises above about 3.5 GPA as measured by SAW techniques and greater than about 7.4 GPa as measured by nano-indentation.

15. The structure of claim 13 wherein the porous dielectric layer comprises a k value between about 2.2 to about 2.4.

16. The structure of claim 13 wherein the porous dielectric layer comprises a porosity of about 24 percent to about 40 percent.

17. The structure of claim 13 wherein the porous dielectric layer comprises up to about a 60 percent reduction rate in SiH bonds.

18. The structure of claim 13 wherein the porous dielectric layer comprises a multimodal pore size distribution, wherein the pore size comprises greater than about a 1.3 nm radius.

19. The structure of claim 13 wherein the porous dielectric layer comprises a carbon doped oxide ILD disposed in a microelectronic device.

20. The structure of claim 19 wherein the porous dielectric layer provides an insulator material between conductive lines in a device.
